(19) United States
(12) Patent Application Publication
(10) Pub. No.: US 2009/0254214 A1
(43) Pub. Date: Oct. 8, 2009

(54) VIAL DISPENSING MECHANISM

(75) Inventors: Keith Kudera, Merriam, KS (US); Ron Leonard, Peculiar, MO (US)

Correspondence Address: HOVEY WILLIAMS LLP, 10801 Mastin Blvd., Suite 1000, Overland Park, KS, 66210, US

(73) Assignee: ScriptPro LLC, Mission, KS (US)

(21) Appl. No.: 12/417,195

(22) Filed: Apr. 2, 2009

Related U.S. Application Data
(60) Provisional application No. 61/042,091, filed on Apr. 3, 2008.

(51) Int. Cl. G06F 17/00; B65D 83/00

(52) U.S. Cl. 700/231; 221/282; 221/12

(57) ABSTRACT

A vial dispensing mechanism for dispensing oblong or other non-cylindrical shaped vials. The vial dispensing mechanism includes at least one spirally-disposed guide wall that defines a vial delivery chute for guiding a plurality of vials; a rotatable platter positioned below the guide wall; a motor coupled with the rotatable platter; and a control system for selectively directing the motor to rotate the platter in a first direction to load the vials into the vial dispensing mechanism or in a second direction to dispense the vials from the vial dispensing mechanism.

### RELATED APPLICATION

This nonprovisional patent application claims priority benefit, with regard to all common subject matter, of earlier-filed U.S. provisional patent application titled “VIAL DISPENSING MECHANISM”, Ser. No. 61/042,091, filed Apr. 3, 2008. The identified earlier-filed application is hereby incorporated by reference in its entirety into the present application.

### FIELD

The present invention relates to mechanisms for dispensing open-top bottles and containers such as medicament vials.

### BACKGROUND

Automatic medicament dispensing systems, such as the ones disclosed in U.S. Pat. No. 5,337,919, require a supply of empty vials for filling with pills or other medicaments. Many different types of vial dispensers have been developed for this purpose. For example, U.S. Pat. No. 5,337,3919 describes an automatic vial dispensing mechanism comprising a rotating spider wheel with outwardly extending pickup arms that successively plunge through a mass of vials randomly positioned in a bin or other large container. The arms lift the empty vials from the bin and drop them into a delivery chute. Other less sophisticated vial dispensers merely include an elongated upright delivery chute in which vials are manually inserted and gravity-fed to a lower discharge area much like a Dixie® cup dispenser.

Although prior art vial dispensers work reasonably well for conventional cylindrical-shaped vials, they do not work well for oblong or other irregular-shaped vials or bottles.

### SUMMARY

Embodiments of the present invention provide a vial dispensing mechanism that more effectively dispenses oblong or other non-cylindrical shaped vials. One embodiment of the vial dispensing mechanism comprises at least one spirally-disposed guide wall that defines a vial delivery chute for guiding a plurality of vials; a rotatable platter positioned below the guide wall; a motor coupled with the rotatable platter; and a control system for selectively directing the motor to rotate the platter in a first direction to load the vials into the vial dispensing mechanism or in a second direction to dispense the vials from the vial dispensing mechanism.

This summary is provided to introduce a selection of concepts in a simplified form that are further described below in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF DRAWING FIGURES

Preferred embodiments of the present invention are described in detail below with reference to the attached drawing figures, wherein:

FIG. 1 is a perspective view of a vial dispensing mechanism constructed in accordance with an embodiment of the invention with the cover plate thereof shown partially fragmented to more clearly illustrate the vials positioned in the mechanism;

FIG. 2 is a side elevational view of the vial dispensing mechanism;

FIG. 3 is a perspective view of the vial dispensing mechanism with the guide walls and cover plate removed; and

FIG. 4 is a bottom perspective view of the dispensing mechanism.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF EMBODIMENTS

The following detailed description of embodiments of the invention references the accompanying drawings that illustrated specific embodiments in which the technology can be practiced. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

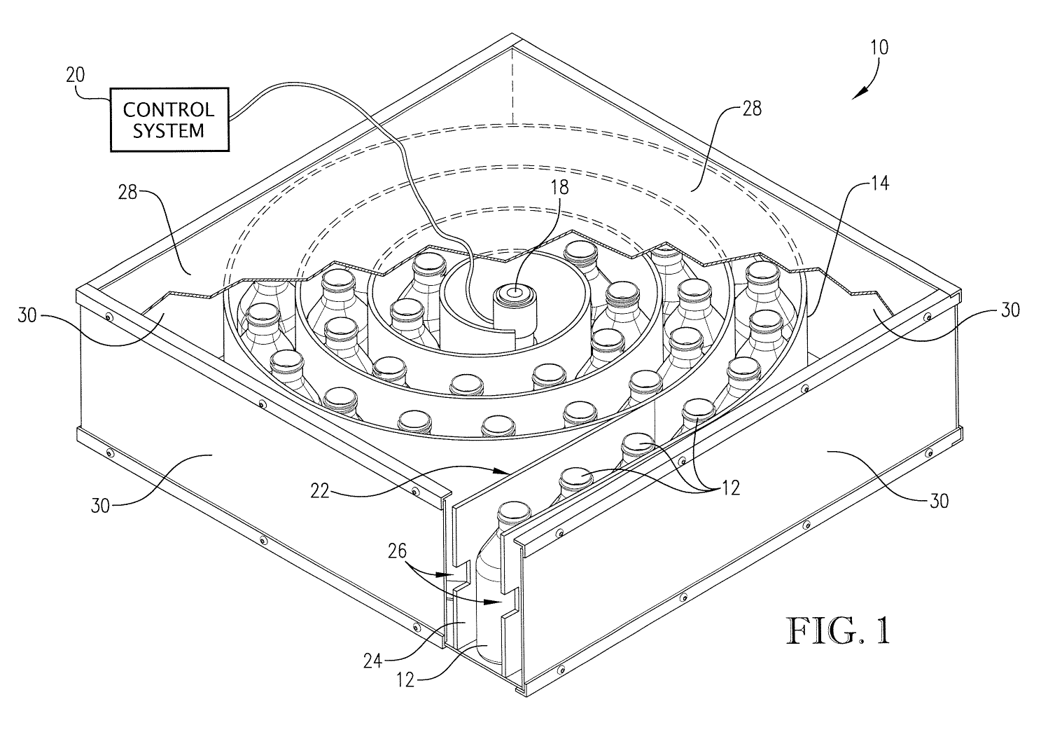

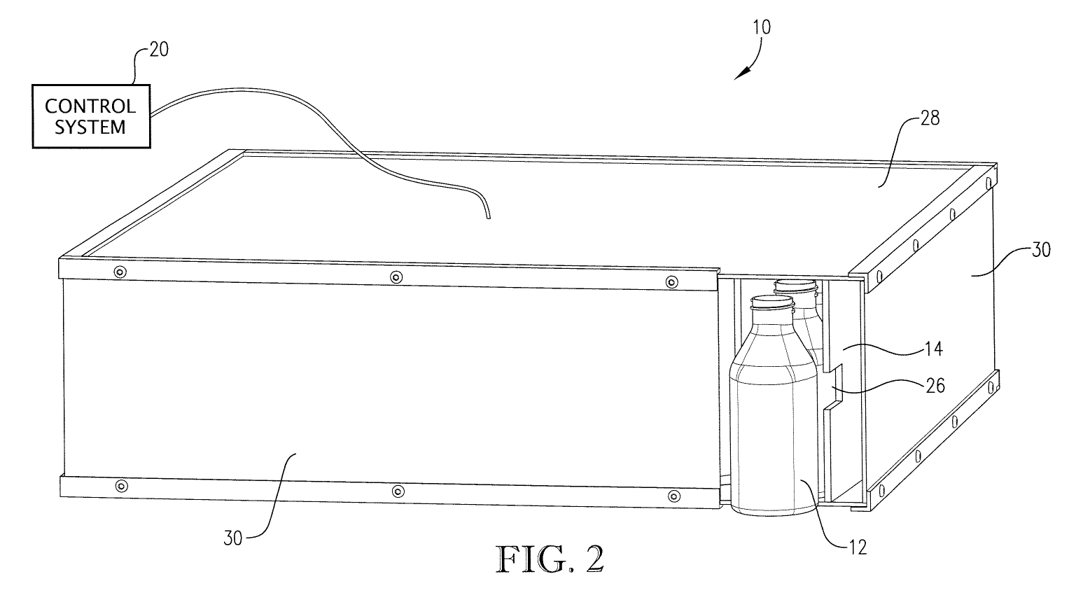

The present invention provides a vial dispensing mechanism 10 that more effectively dispenses oblong and other irregular-shaped vials 12 such as those shown in FIGS. 1-4. The vial dispensing mechanism 10 may be used with an automatic medicament dispensing system such as the ones described in U.S. Pat. No. 5,337,919, which is hereby incorporated by reference in its entirety, or the SP 200 dispensing system manufactured and sold by ScriptPro LLC of Mission, Kans.

The illustrated embodiment of the vial dispensing mechanism 10 broadly includes at least one upstanding guide wall 14; a rotatable circular platter 16 positioned under the guide wall 14; a drive mechanism 18 for rotating the platter 16 relative to the guide wall 14; and a control system 20 for controlling operation of the drive mechanism.

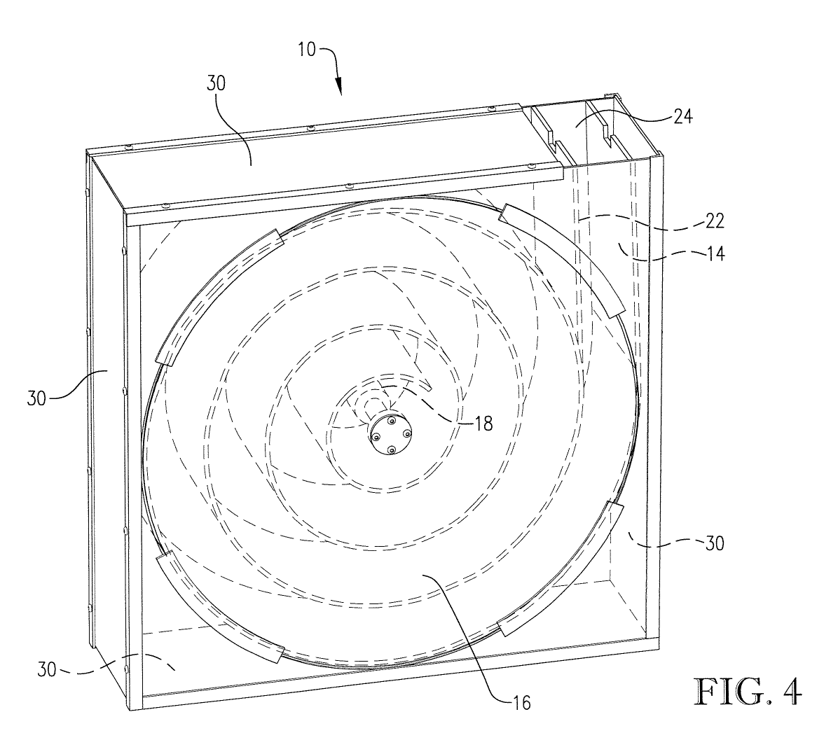

The guide wall 14 is spirally disposed or positioned as best shown in FIGS. 1 and 4 to form a spiral shaped delivery chute. The radius of the spiral, and thus the spacing between adjacent portions of the guide wall, is selected so that the width of the delivery chute is slightly greater than the width of the vials but less than the length of the vials. This keeps the vials positioned sideways (with the narrowest portion of the vials leading) in the delivery chute, the importance of which is discussed below. In one embodiment, the distance between adjacent sections of the guide wall, and therefore the width of the delivery chute, is 1/32″ wider than the narrowest width of the vials to be dispensed by the vial dispensing mechanism, and the height of the guide wall is greater than the height of the vials. For example, when used with vials that are 3″ long, 1″ wide, and 7″ tall, the guide wall is at least 7″ tall and is arranged to form a delivery chute approximately 1 1/32″ wide. The guide wall 14 may be formed of any suitable material such as metal, plastic, or fiberglass.

A second relatively short guide wall 22 may be positioned adjacent the outermost end of the guide wall 14 to define an exit area 24 for presenting vials for pick-up by a vial transporting mechanism of a medicament dispensing system. The guide walls at the exit area may include cut-outs 26 for accommodating gripping arms of the vial transporting mechanism.

The dispensing mechanism 10 may also include a cover plate 28 for covering the other components of the mechanism and supporting the guide walls 14, 22 and drive mechanism 18. In one embodiment, the upper edges of the guide wall 14 and 22 are affixed to the lower face of the cover plate 28 by adhesives, welding, or any other attachment method. In other embodiments, the guide walls 14, 22 and cover plate 28 may be molded or otherwise integrally formed as a single piece or may be unattached to one another. The cover plate may be formed in any shape or size and of any suitable material such as metal, glass, plastic, etc. In one embodiment, the cover plate 28 is formed of transparent plastic or glass and is square as shown.

The rotatable platter 16 is positioned below the guide walls 14, 22 and supports and moves the vials along the vial delivery chute when the platter is rotated. The platter 16 may be formed of any suitable material such as metal, plastic, or fiberglass. The platter may be cut or otherwise formed from a larger square-shaped bottom plate as best shown in FIG. 4 so that the corners or edges of the bottom plate remain stationary relative to the platter.

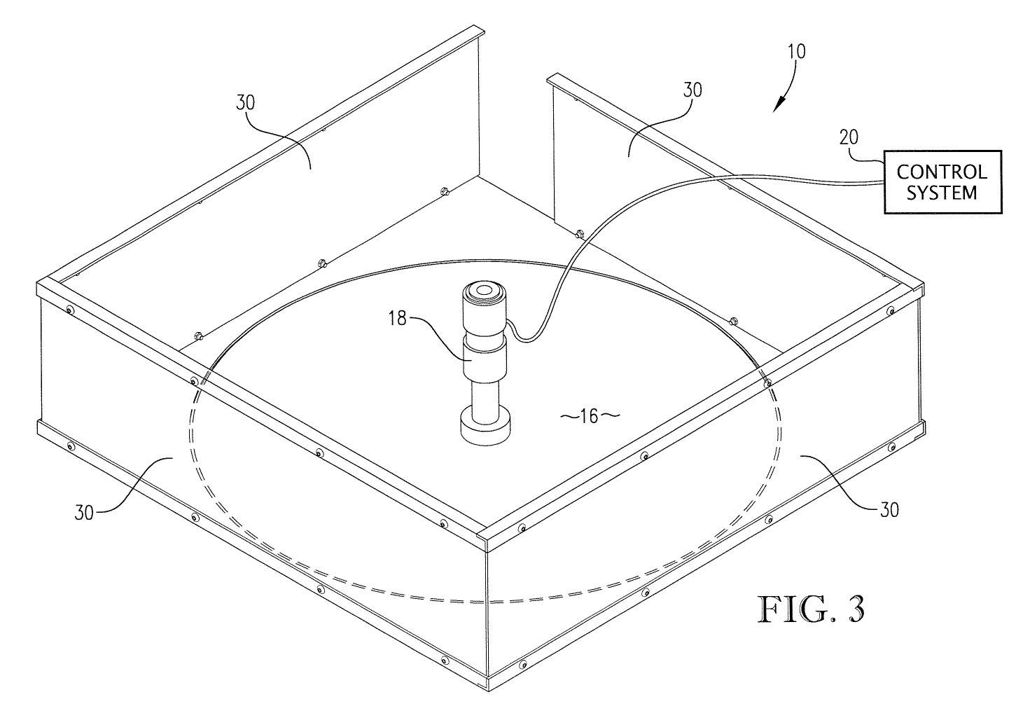

The drive mechanism 18 rotates the platter 16 in either a first counter-clockwise direction (when viewed from the perspective of FIG. 1) to load vials into the delivery chute or in a second clockwise direction to dispense the vials from the vial dispensing mechanism. As the platter rotates, it urges the vials against the guide wall 14, which directs the vials either toward or away from the center of the dispensing mechanism depending on the rotation direction of the platter. In one embodiment, the drive mechanism is a reversible electric motor that rotates at a speed of approximately 4 RPM, but it may operate at any desired speed. As best shown in FIGS. 1 and 3, the housing or outer enclosure of the electric motor 20 is secured to the bottom of the cover plate 12 and the rotatable shaft of the motor is secured to the circular platter 18 so that the motor rotates the platter relative to the cover plate and delivery chute.

The drive mechanism may also be a coil spring with a racheting mechanism or any other drive mechanism capable of rotating the platter relative to the delivery chute.

The control system 20 synchronizes operation of the drive mechanism 18 with other components of an automatic medicament dispensing system. The control system may include any number of controllers, processors, or other computing devices and may be integrated into the overall control system of the medicament dispensing system or may be a stand-alone control system. In one embodiment, the control system receives a signal from a proximity sensor that is positioned near the exit area 24 to sense the presence of a vial. When the proximity sensor senses no vials near the exit area, it signals the control device to rotate the platter, and when it senses a vial, it signals the control device to stop the platter. The proximity sensor may consist of an emitter and collector or any other type of proximity sensing components.

The dispensing mechanism may also include an outer frame consisting of four side panels 30, each fixed between a side edge of the cover plate and a side edge of the bottom plate. The frame permits mounting of the vial dispensing mechanism within or adjacent to a medicament dispensing system.

In operation, vials 12 are loaded into the vial dispensing mechanism 10 by individually introducing them into the exit area 24 of the delivery chute while the drive mechanism 18 rotates the platter in a counter-clockwise direction. This moves the vials toward the center of the vial dispensing mechanism. Once the vial dispensing mechanism is at least partially full and ready to dispense vials, the drive mechanism 18 may be operated to rotate the platter 16 in a clockwise direction to deliver the vials 12, one at a time, to the exit area 24 for pick-up by a vial transporting mechanism of a medicament dispensing system.

Although the invention has been described with reference to the embodiments illustrated in the attached photos, equivalents may be employed and substitutions made without departing from the scope of the invention.

Having thus described preferred implementations of the present technology, what is claimed as new and desired to be protected by Letters Patent includes the following:

1. A vial dispensing mechanism comprising:
a spirally-disposed vial delivery chute for receiving a plurality of vials; and
a rotatable platter positioned below the vial delivery chute for moving the vials along the delivery chute in or out of the vial dispensing mechanism.

2. The vial dispensing mechanism as set forth in claim 1, further including a motor for selectively rotating the rotatable platter in a first direction to load the vials into the vial dispensing mechanism and in a second direction to dispense the vials, one at a time, from the vial dispensing mechanism.

3. The vial dispensing mechanism as set forth in claim 2, further including a control system for controlling operation of the motor.

4. The vial dispensing mechanism as set forth in claim 2, further including a cover plate for supporting the delivery chute and the motor above the rotatable platter.

5. The vial dispensing mechanism as set forth in claim 1, further including a frame for partially enclosing the vial delivery chute and the rotatable platter and permitting mounting of the vial dispensing mechanism within a rack or cabinet.

6. The vial dispensing mechanism as set forth in claim 2, wherein the vial delivery chute includes an exit area at which the vials may be picked up, one at a time, by a vial transporting mechanism of a medicament dispensing system.

7. The vial dispensing mechanism as set forth in claim 6, further including a proximity sensor for sensing presence of one of the vials near the exit area and for signaling the motor to stop.

8. The vial dispensing mechanism as set forth in claim 2, wherein the first direction is counter-clockwise and the second direction is clockwise.

9. A vial dispensing mechanism comprising:
at least one spirally-disposed guide wall that defines a spiral vial delivery chute for guiding a plurality of vials in or out of the vial dispensing mechanism;
a rotatable platter positioned below the guide wall;
a drive mechanism coupled with the rotatable platter; and
a control system for selectively directing the drive mechanism to rotate the platter in a first direction to load the vials into the vial dispensing mechanism or in a second direction to dispense the vials from the vial dispensing mechanism.

10. The vial dispensing mechanism as set forth in claim 9, further including a cover plate for supporting the guide wall and the drive mechanism above the rotatable platter.

11. The vial dispensing mechanism as set forth in claim 9, further including a frame for partially enclosing the vial delivery chute and the rotatable platter and permitting mounting of the vial dispensing mechanism within a rack or cabinet.

12. The vial dispensing mechanism as set forth in claim 9, wherein the vial delivery chute includes an exit area at which the vials may be picked up, one at a time, by a vial transporting mechanism of a medicament dispensing system.

13. The vial dispensing mechanism as set forth in claim 12, further including a proximity sensor for sensing presence of one of the vials near the exit area and for signaling the control system to stop rotation of the drive mechanism.

14. The vial dispensing mechanism as set forth in claim 10, wherein the first direction is counter-clockwise and the second direction is clockwise.

15. The vial dispensing mechanism as set forth in claim 9, wherein the drive mechanism is a motor.

16. The vial dispensing mechanism as set forth in claim 9, wherein the control system synchronizes operation of the drive mechanism with operation of an automatic medicament dispensing system.
